(19) United States
(12) Patent Application Publication
(10) Pub. No.: US 2003/0136056 A1
(43) Pub. Date: Jul. 24, 2003

(54) Magnetic-abrasive powder and method of producing the same

(76) Inventors: Gennady Kremen, Brooklyn, NY (US); Leonid Igelshteyn, Manalapan, NJ (US); Savva Feygin, Manalpan, NJ (US)

Correspondence Address: Ilya Zborovsky, 6 Schoolhouse Way, Dix Hills, NY, 11746, US

(21) Appl. No.: 10/053,635

(22) Filed: Jan. 24, 2002

(51) Int. Cl. H01F 1/00

(52) U.S. Cl. 51/298; 51/293; 51/307; 51/309; 252/62.54

(57) ABSTRACT

A magnetic-abrasive powder has a magnetic component, an abrasive component, an adhesive component which connects particles of the magnetic component with particles of the abrasive component, the adhesive component being a light curing adhesive component which contains catalysts and is polymerizable under the action of ultraviolet and visible light.

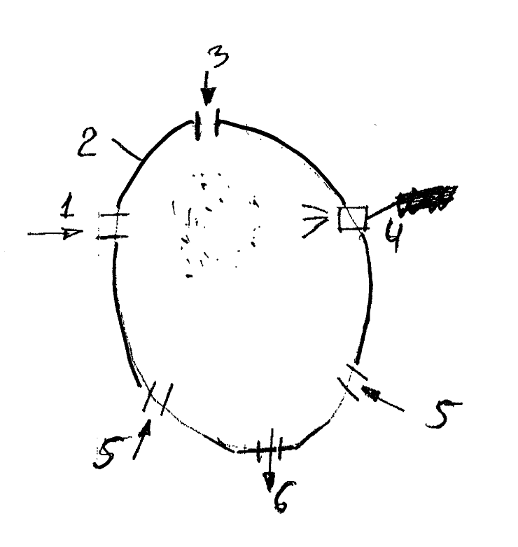

### BACKGROUND OF THE INVENTION

The present invention relates to a magnetic-abrasive powder and a method of producing such a powder.

A magnetic-abrasive powder is utilized for magnetic-abrasive machining of parts. In the magnetic-abrasive machining, the magnetic-abrasive powder is introduced into a magnetic field and applied to a surface of a part to be machined by a magnetic force. Our U.S. Pat. No. 5,846,270 discloses a magnetic abrasive powder. It includes a magnetic component composed of a powder of a magnetic material, and an adhesive which adhesively connects the particles of the magnetic material with the particles of the abrasive material. The adhesive component for the magnetic-abrasive powder can include for example a cyanacrylate glue, for example cyanacrylate monomer in a liquid phase of the series 100, 200, 400, 800, etc which is known commercially as an industrial crazy glue.

While the above described magnetic abrasive powder is very efficient during an industrial manufacture of the magnetic abrasive powder when it is necessary to mix large quantities of abrasive, magnetic and adhesive material, the latter stops glueing before the adhesive connection of all components of the magnetic abrasive powder.

### SUMMARY OF THE INVENTION

Accordingly, it is an object of the present invention to provide a magnetic abrasive powder and a method of producing the same which avoids the disadvantages of the prior art.

In keeping with these objects and with others which will become apparent hereinafter, one feature of present invention resides, briefly stated, in a magnetic abrasive powder which has a magnetic powder component, an abrasive powder component, and a light-curing adhesive component which contains catalysts and which adhesively binds the abrasive powder component to the magnetic powder component, and a polymerization occurs under exposure to high intensity ultraviolet or visible light.

In accordance with another feature of the present invention, a method of producing a magnetic abrasive powder is proposed, which includes the steps of mixing a magnetic powder component with an abrasive powder component and a light-curing adhesive component containing catalysts, and subjecting to exposure to high intensity ultraviolet or visible light to cause polymerization.

While for the magnetic abrasive powder disclosed in our older patent it is possible to glue not more than tenths grams of mixture composed of powders of abrasive and iron, when the mass is much greater the adhesive rigidifies before it glues the ingredients of the mixture. To the contrary, when the magnetic-abrasive powder is formed and prepared in accordance with the present invention, it avoids the disadvantages of the prior art. It is possible to produce considerably greater quantities of the magnetic-abrasive powder.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view showing schematically a device for preparing a magnetic-abrasive powder with the use of great masses of an abrasive material and a magnetic material.

### DESCRIPTION OF THE PREFERRED EMBODIMENTS

A magnetic-abrasive powder in accordance with the present invention includes a magnetic component. The magnetic component can be for example a powder of a magnetic material, such as iron. Conventionally, iron is inexpensive and has high magnetic properties. The inventive magnetic-abrasive powder further includes an abrasive component. The abrasive component can be a powder of desired abrasive, such as for example diamond, carbide, nitride, boride, oxide powder, etc.

In the inventive magnetic-abrasive powder, the magnetic component and the abrasive component are intermixed and connected and bound with one another. For connecting or binding of these components, or more particularly of the particles of the magnetic powder and the abrasive powder, an adhesive component is utilized.

In accordance with the present invention, an adhesive component for connecting with one another the particles of the magnetic component with the particles of the abrasive component is such an adhesive which has a catalyst and is polimerizable under the action of ultraviolet or visible light. For example, it is possible to use the adhesive known as ultra-light weld 104-MSK produced by Dymax Corporation.

In order to manufacture significant quantities of the magnetic abrasive powder, for example tenths kg of the mixture of the powders of iron and abrasive, a device shown in the drawing can be utilized. Before blowing of the mixture of the powders of iron and abrasive, the iron powder and the abrasive powder are mixed in desired proportions. The mixture 1 is introduced into a chamber 2. An adhesive 3 is introduced into the same chamber. The adhesive glues separate fragments or particles of the mixture which are suspended in a jet only under the action of the ultraviolet or visible light. The ultraviolet or visible light can be provided by a Dymax 2000-EC UV/visible lamp.

Air 5 is introduced into the chamber from below and under pressure. The pressure of air is controlled so as to support individual particles of iron and abrasive in a suspended condition. However, it might happen that some glued particles of iron and abrasive fall onto the bottom of the chamber, and they are removed through an opening 6 under the action of gravity.

After the glueing and hardening, the material is treated with known methods for its comminution, for example in a mill.

It will be understood that each of the elements described above, or two or more together, may also find a useful application in other types of constructions and methods differing from the types described above.

While the invention has been illustrated and described as embodied in magnetic-abrasive powder and method of producing the same, it is not intended to be limited to the details shown, since various modifications and structural changes may be made without departing in anyway from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A magnetic-abrasive powder, comprising a magnetic component; an abrasive component, an adhesive component which connects particles of said magnetic component with particles of said abrasive component, said adhesive component being a light curing adhesive component which contains catalysts and is polymerizable under the action of ultraviolet and visible light.

2. A magnetic-abrasive powder as defined in claim 1, wherein said adhesive component is an ultra-light weld 104-msk produced by Dymax Corporation.

3. A method of producing a magnetic-abrasive powder, comprising the steps of mixing a magnetic component and an abrasive component; connecting particles of the magnetic component and the abrasive component by an adhesive component; using as the adhesive component a light-curing adhesive component with catalysts; and polymerizing the adhesive component under the action of ultraviolet or visible light.

4. A method as defined in claim 3, wherein said adhesive component is an ultra-light weld 104-msk produced by Dymax Corporation.

5. A method as defined in claim 3; and further comprising suspending a mixture of the abrasive component and the magnetic component by air so as to perform the connection of the particles of the magnetic component and the abrasive component by the adhesive component in a suspended condition.
